(19) United States
(12) Patent Application Publication
(10) Pub. No.: US 2014/0007092 A1
(43) Pub. Date: Jan. 2, 2014

(54) AUTOMATIC TRANSFER OF WORKLOAD CONFIGURATION

(71) Applicants: Galen Dean Barbee, Issaquah, WA (US); Symon Warner Perriman, Seattle, WA (US); David A. Dion, Bothell, WA (US); Lars Reuther, Kirkland, WA (US); Joydeep Buragohain, Issaquah, WA (US); Andrea D'Amato, Kirkland, WA (US); Alan Warwick, Bellevue, WA (US); Ting Liang, Mountain View, CA (US)

(72) Inventors: Galen Dean Barbee, Issaquah, WA (US); Symon Warner Perriman, Seattle, WA (US); David A. Dion, Bothell, WA (US); Lars Reuther, Kirkland, WA (US); Joydeep Buragohain, Issaquah, WA (US); Andrea D'Amato, Kirkland, WA (US); Alan Warwick, Bellevue, WA (US); Ting Liang, Mountain View, CA (US)

(73) Assignee: MICROSOFT CORPORATION, Redmond, WA (US)

(21) Appl. No.: 13/539,332

(22) Filed: Jun. 30, 2012

(51) Int. Cl. G06F 9/455

(52) U.S. Cl. 718/1

(57) ABSTRACT

The present invention extends to methods, systems, and computer program products for automatically transferring configuration of a virtual machine from one cluster to another cluster. The invention enables an administrator to transfer configuration of a virtual machine by simply specifying a virtual machine to be transferred. The invention then inspects the configuration of the virtual machine on the old cluster as well as the configuration of the old cluster, including the storage (e.g. virtual hard disk) used by the cluster, and then configures a new virtual machine on a new cluster accordingly to match the configuration of the old virtual machine. Similar techniques can also be applied to transfer configuration of an SMB file server.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

Clusters of servers are often used to host services. For example, a virtual machine is a type of service that can be hosted on a cluster of servers. A cluster is a physical grouping of servers in a manner that each server in the cluster can access common resources, such as a storage array and networks.

It is often desirable to replace a server in a cluster or the entire cluster. Various reasons exist for performing such a replacement such as: incorporating more powerful server hardware; adding a new operating system or other software to a server; and consolidating multiple servers or clusters into fewer (likely more powerful) servers or clusters. When replacing a server or a cluster, it is generally advantageous to replace the server or cluster without replacing the associated infrastructure, such as the shared storage array or the shared network.

However, replacing a server (or a cluster) without replacing the shared storage array or network can be a difficult and tedious process. In current approaches, the administrator is required to manually configure the virtual machine or other service on the new cluster. This manual configuration includes configuring the virtual machine definition on the new server, configuring the new server to host the virtual machine (e.g. reconfiguring a shared storage array, mapping the virtual machine to the appropriate file location in the reconfigured storage array, etc.), and migrating the files to the reconfigured shared storage array (or creating new files on the reconfigured shared storage array).

Existing techniques exist for migrating a virtual machine (or other workload) from one node to another. Migrating a virtual machine involves moving virtual machine configuration data from one node to the other. Migration is similar in some regards to the configuration techniques of the present invention. However, migration tools are limited. A key feature of migration is that a virtual machine may be migrated without the virtual machine experiencing any downtime. To provide this high level of availability, migration tools can only migrate a virtual machine (or other workload) in limited environments.

For example, migration tools may not allow a virtual machine to be migrated between nodes running different operating systems, having different architectures, or using different clustered file systems. When a migration tool does not support migration between two nodes or clusters, the administrator is required to manually configure the virtual machine on the new node or cluster which can be a difficult process.

### BRIEF SUMMARY

The present invention extends to methods, systems, and computer program products for automatically transferring configuration of a virtual machine from one cluster to another cluster. The invention enables an administrator to transfer configuration of a virtual machine by simply specifying a virtual machine to be transferred. The invention then inspects the configuration of the virtual machine on the old cluster as well as the configuration of the old cluster, including the storage (e.g. virtual hard disk) used by the cluster, and then configures a new virtual machine on a new cluster accordingly to match the configuration of the old virtual machine. Similar techniques can also be applied to transfer configuration of an SMB file server.

This configuration can include updating paths to files or other data on the shared volume in the new cluster as necessary such as when the shared volume in the new cluster utilizes a different storage structure than the old shared volume in the old cluster. This configuration can also include copying files from the old cluster to the new cluster or creating new files in the new cluster.

In one embodiment, the configuration of a workload is transferred from an old cluster to a new cluster. Input is received that requests that the workload configuration be transferred from the old cluster to the new cluster. Configuration settings of the workload on the old cluster are then automatically determined. The configuration settings include mappings between the workload and a cluster file system on the old cluster.

A staged workload is created on the new cluster. The staged workload is adapted on the new cluster while the workload continues to run on the old cluster. The adapting includes adapting the configuration settings to create new mappings between the staged workload and a cluster file system on the new cluster. The workload on the old cluster is stopped, and the staged workload is started on the new cluster to replace the workload on the old cluster.

In another embodiment, the configuration of one or more virtual machines is transferred from an old server to a new server. Input is received to a configuration transfer wizard. The input selects one or more virtual machines that are executing on the old server. Configuration settings of each of the one or more virtual machines are automatically determined.

A staged virtual machine is created on the new server for each of the one or more virtual machines. Each staged virtual machine is adapted on the new server while each virtual machine continues to execute on the old server. The adapting comprises modifying the determined configuration settings for each staged virtual machine such that, once deployed, each staged virtual machine is configured to function in a similar manner on the new server as the corresponding virtual machine functioned on the old server. Each virtual machine is stopped on the old server, and each staged virtual machine is deployed on the new server.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates the automatic transfer of the configuration of a virtual machine from one cluster to another cluster;

FIGS. 2A-2B illustrate various steps performed within the exemplary computer architecture to transfer configuration of a virtual machine from one cluster to another;

FIG. 3 illustrates an exemplary cluster environment in which configuration of a virtual machine can be transferred;

FIG. 4 illustrates various specific scenarios in which the configuration transfer techniques of the present invention can be implemented;

FIG. 5 illustrates a flow chart of an example method for automatically transferring configuration of a workload from an old cluster to a new cluster; and

FIG. 6 illustrates a flow chart of an example method for automatically transferring configuration of one or more virtual machines from an old server to a new server.

### DETAILED DESCRIPTION

The present invention extends to methods, systems, and computer program products for automatically transferring configuration of a virtual machine from one cluster to another cluster. The invention enables an administrator to transfer configuration of a virtual machine by simply specifying a virtual machine to be transferred. The invention then inspects the configuration of the virtual machine on the old cluster as well as the configuration of the old cluster, including the storage (e.g. virtual hard disk) used by the cluster, and then configures a new virtual machine on a new cluster accordingly to match the configuration of the old virtual machine. Similar techniques can also be applied to transfer configuration of an SMB file server.

This configuration can include updating paths to files or other data on the shared volume in the new cluster as necessary such as when the shared volume in the new cluster utilizes a different storage structure than the old shared volume in the old cluster. This configuration can also include copying files from the old cluster to the new cluster or creating new files in the new cluster.

In one embodiment, the configuration of a workload is transferred from an old cluster to a new cluster. Input is received that requests that the workload configuration be transferred from the old cluster to the new cluster. Configuration settings of the workload on the old cluster are then automatically determined. The configuration settings include mappings between the workload and a cluster file system on the old cluster.

A staged workload is created on the new cluster. The staged workload is adapted on the new cluster while the workload continues to run on the old cluster. The adapting includes adapting the configuration settings to create new mappings between the staged workload and a cluster file system on the new cluster. The workload on the old cluster is stopped, and the staged workload is started on the new cluster to replace the workload on the old cluster.

In another embodiment, the configuration of one or more virtual machines is transferred from an old server to a new server. Input is received to a configuration transfer wizard. The input selects one or more virtual machines that are executing on the old server. Configuration settings of each of the one or more virtual machines are automatically determined.

A staged virtual machine is created on the new server for each of the one or more virtual machines. Each staged virtual machine is adapted on the new server while each virtual machine continues to execute on the old server. The adapting comprises modifying the determined configuration settings for each staged virtual machine such that, once deployed, each staged virtual machine is configured to function in a similar manner on the new server as the corresponding virtual machine functioned on the old server. Each virtual machine is stopped on the old server, and each staged virtual machine is deployed on the new server.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

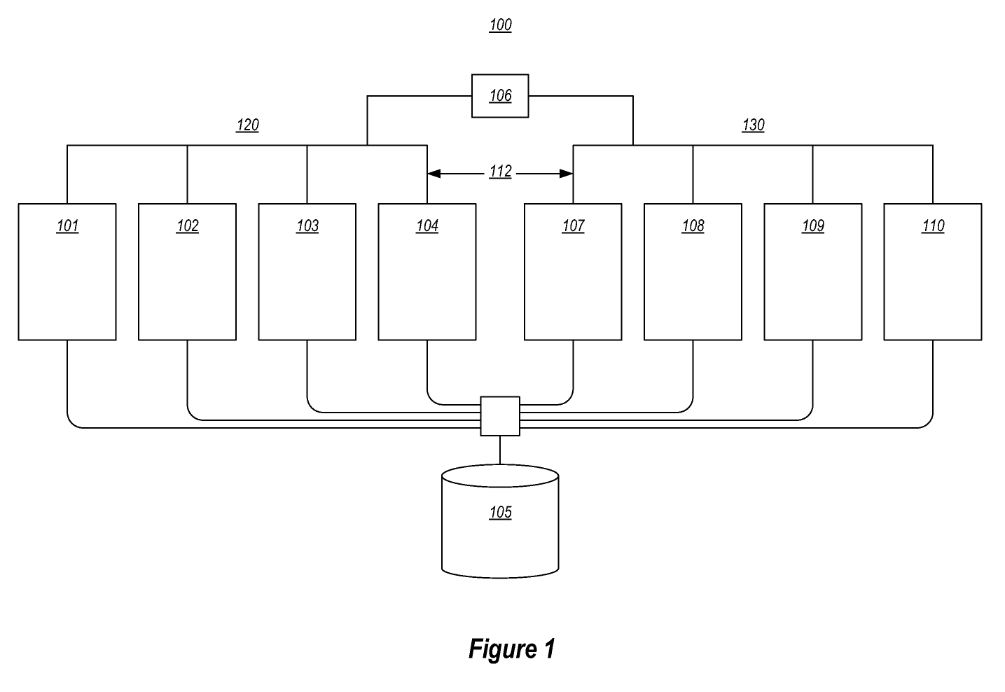

FIG. 1 illustrates an example computer architecture 100 that facilitates the automatic transfer of the configuration of a virtual machine from one cluster to another cluster. Referring to FIG. 1, computer architecture 100 includes two clusters, an old cluster 120 and a new cluster 130. The new cluster uses the same shared storage 105 as the old cluster. The invention will be described in the context of a virtual machine being moved from old cluster 120 to new cluster 130.

Old cluster 120 includes four nodes (or servers) 101-104 and uses shared storage 105. New cluster 130 also includes four nodes 107-110 and will use shared storage 105. Although four nodes are shown in each cluster, each cluster can include any number of nodes. Additionally, shared storage 105 can represent any number of physical storage devices. For example, shared storage 105 can include an array of storage devices that are managed as a single logical entity. Shared storage 105 includes one or more cluster file systems (e.g. a CSV in a Microsoft specific implementation).

Cluster 130 can represent a cluster having a different platform (e.g. Windows Server 8) than cluster 120 (e.g. Windows Server 2008 R2). Cluster 130 can also represent a cluster having the same platform (e.g. Windows Server 8) as cluster 120. In other words, the configuration of a virtual machine can be transferred to an upgraded cluster or to a similar cluster.

The present invention can also be used to facilitate the upgrade of a cluster to a newer clustered file system. For example, an administrator may be running a cluster with an older platform/clustered file system and may desire to upgrade to a newer platform/clustered file system. The invention facilitates such upgrades by enabling the administrator to specify a virtual machine on cluster 120 (with the older platform) whose configuration is to be transferred to cluster 130 (with the newer platform).

Computer architecture 100 also includes a client 106. Client 106 is depicted to illustrate that an administrator can interact with each cluster from a computer system outside the clusters. However, an administrator can employ the configuration transfer techniques of the present invention by utilizing a separate client (e.g. client 106) or by utilizing any one of the servers of cluster 120 or cluster 130. In other words, the location from which the administrator instructs the transfer of the configuration of a virtual machine is not essential to the invention.

Each of the depicted servers and shared storage as well as client 106 is shown as being connected via network 112. A single network is shown for simplicity. However, in a typical implementation, the nodes of each cluster are interconnected by multiple networks. Similarly, client 106 may connect to clusters 120 and 130 over a different network than the network over which cluster 120 and cluster 130 communicate. Accordingly, the network configuration used to connect the depicted computer systems is not essential to the invention.

Network 112 can represent a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

The features of the present invention can be provided via a tool such as a configuration transfer wizard. The tool can provide a user interface through which an administrator can specify one or more virtual machines whose configuration is to be transferred from cluster 120 to cluster 130. For example, an administrator can access the tool from client 106. The tool can also be accessed from any of servers 107-110 or even from servers 101-104. The tool can present to the administrator a list of all virtual machines on cluster 120 that are available for configuration transfer. The administrator can select a particular virtual machine (or more than one virtual machine), or otherwise specify a virtual machine to the tool.

In response to the administrator's selection of a virtual machine, the tool automatically performs the necessary functions to determine configuration settings of the selected virtual machine on cluster 120 as well as pertinent configuration settings of cluster 120 including those of a cluster file system on shared storage 105. The gathered configuration settings are then used to automatically configure a virtual machine on cluster 130 to function the same as the selected virtual machine on cluster 120. In essence, the configuration of the selected virtual machine is transferred from cluster 120 to cluster 130.

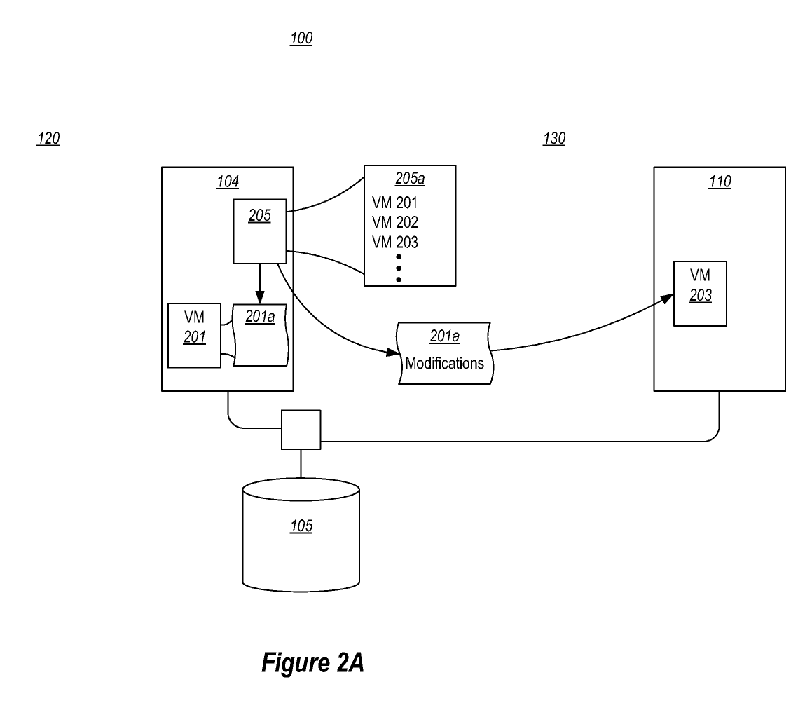

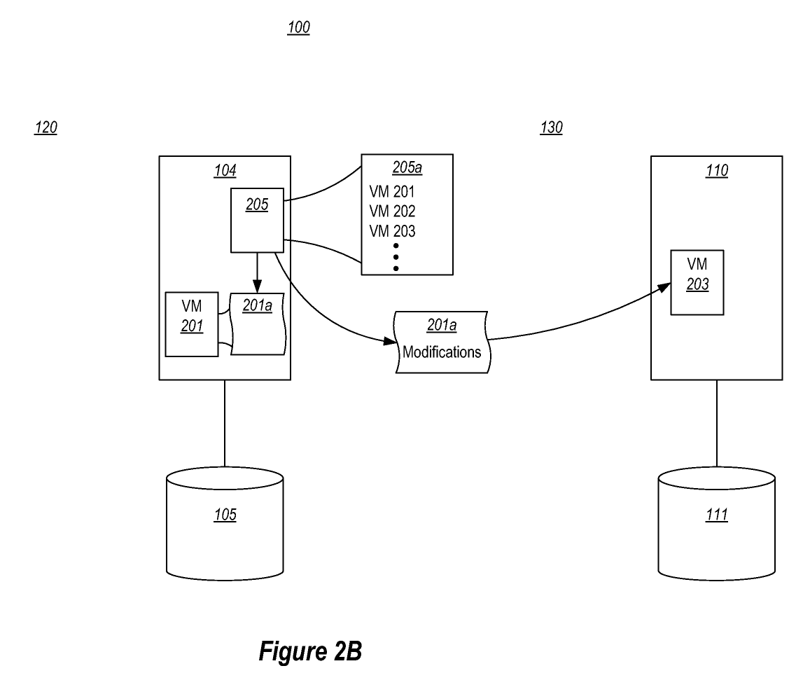

FIG. 2A illustrates various steps performed within computer architecture 100 to transfer configuration of a virtual machine from cluster 120 to cluster 130. For sake of clarity, only node 104 and node 110 are shown from clusters 120 and 130 respectively. FIG. 2A depicts tool 205 which may be executing on any of the nodes of cluster 230, but is shown as being executed on node 104. Tool 205 can also be executed on any of the nodes of cluster 120 or even on client 106. Additionally, a user interface (UI) 205a for tool 205 can be displayed to an administrator on any computer system connected to tool 205 such as, for example, client 106.

As shown, UI 205a displays a list of virtual machines whose configuration can be transferred from cluster 120 to cluster 130. In this example, the administrator has selected VM 201, which is executing on node 104, for configuration transfer. For simplicity, only one VM is shown as being selected, however, any number of VMs (including all VMs in the cluster) can be selected for configuration transfer at the same time. In response to this selection, tool 205 inspects the configuration settings 201a associated with VM 201. These configuration settings include settings that define the configuration of VM 201 such as where VM 201's data is stored within cluster 120 (such as the volumes of the clustered file system where the data is stored), settings that define the architecture of the virtual network employed by VM 201 (e.g. which virtual switches VM 201 uses to communicate with other VMs within cluster 120), a name of VM 201, the number of processors VM 201 is assigned, the amount of memory available to VM 201, the location where a snapshot file or paging file used by VM 201 is stored, the priority of VM 201 relative to other VMs in cluster 120, etc.

Although FIG. 2A shows configuration settings 201a as being part of VM 201 on node 104, tool 205 accesses configuration settings for VM 201 from other locations within cluster 120. For example, some of configuration settings 201a can be determined by accessing files or settings that are stored on storage 105 or on other nodes of cluster 120. Accordingly, tool 205 can inspect configuration settings from many different locations within cluster 120 to accumulate configuration settings 201a which are pertinent to VM 201.

Once tool 205 has determined the necessary configuration settings for transferring configuration of VM 201, tool 205 configures cluster 130 appropriately to create VM 203 based on the determined configuration settings 201a. This process can involve copying some of configuration settings 201a directly to cluster 130. For example, tool 205 can create appropriate mappings to storage locations in storage 105 that are to be used by VM 203.

However, for some configuration settings (as more particularly described below), tool 205 must modify the configuration settings to adapt the configuration settings to cluster 130. For example, to configure VM 203 on cluster 130 to match VM 201 as it was configured on cluster 120, it may be necessary to apply different configuration settings than those determined in configuration settings 201a. As shown in FIG. 2A, configuration settings 201a applied to VM 203 include modifications.

Examples of configuration settings that may be adapted include mappings to volumes in the clustered file system employed by cluster 130. For example, cluster 130 may employ a clustered file system with a different namespace such that the location of a required file (e.g. configuration files, VHD files, snapshot files, paging files, etc.) will have a different path in cluster 130 than it did in cluster 120. In such cases, tool 205 can determine the appropriate configuration settings to apply to VM 203 to ensure that VM 203 interfaces appropriately with the different clustered file system.

Similarly, cluster 130 may employ a different virtual network architecture. For example, tool 205 can modify mappings to the virtual network switches (or other virtual network devices) used by VM 201 (as defined in configuration settings 201a) so that the modified mappings map to appropriate virtual switches in cluster 130. Additionally, cluster 130 may employ a different VM prioritization scheme. Tool 205 can map the priority of VM 201 in cluster 120 to an appropriate priority level for VM 203 in cluster 130.

After tool 205 has performed each of these configuration transfer steps, VM 203 will be configured in cluster 130 to function in the same manner as VM 201 functioned in cluster 120 (i.e. VM 203 will be remapped to the same files that VM 201 has been using). Importantly, this process will occur without requiring the administrator to manually create and configure VM 203 on cluster 130, and while VM 201 continues to execute on cluster 120. Accordingly, the present invention greatly facilitates configuration transfer of VMs between clusters.

It is noted that the above example assumes that cluster 130 is physically connected to the same shared storage (storage 105) that cluster 120 used (e.g. via a direct physical connection (either by connecting both clusters to storage 105 or by disconnecting cluster 120 from and connecting cluster 130 to storage 105) or via a network connection such as iSCSI, NFS, SMB, etc.). However, the same configuration transfer techniques can be applied when different shared storage is used by cluster 130.

For example, as shown in FIG. 2B, a different shared storage (storage 111) is used by cluster 130. Accordingly, the required files are copied from storage 105 to storage 111. Then, tool 205 can be used to automatically map VM 203 to the location of the required files on storage 111 in the manner described above. It is noted that when different shared storage is used, it may be required that VM 201 be stopped before the required files are copied to prevent any inconsistencies that may occur if VM 201 were to change the required files after they were copied. Of course, other techniques (e.g. synchronization of the copied files) could be used to allow VM 201 to continue executing after the required files are copied.

The above described configuration transfer process can be especially beneficial when transferring configuration of a VM from a cluster with an older version of a clustered file system or operating system to a cluster with a newer version of the clustered file system or operating system. In other words, the invention provides an automatic upgrade path for VMs. The process is also beneficial when transferring configuration of a VM between clusters having similar configurations (e.g. the same clustered file system and operating system).

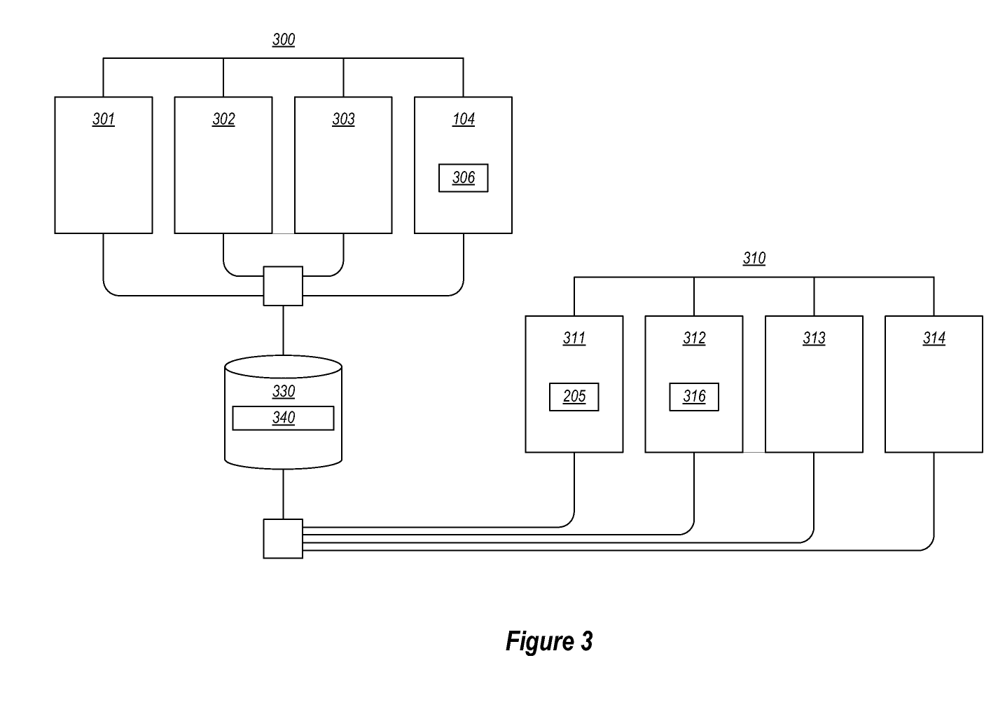

FIG. 3 illustrates an exemplary cluster environment in which configuration of a virtual machine can be transferred. For sake of clarity, and without limiting the invention to Microsoft specific components, cluster 300 will be described using Microsoft specific terminology. Cluster 300 comprises a group of servers (or nodes) 301-304 that each are running Windows Server 2008 R2 with the Hyper-V (hypervisor) role. Cluster 300 employs Windows Server 2008 R2 Cluster Shared Volumes (CSV) to enable any of the nodes in cluster 300 to access any shared volumes on storage 330. Node 304 is shown as including a VM 306. Cluster 310, once configured, will also use storage 330.

In this exemplary implementation, an administrator of VM 306 has determined that he would like to upgrade to a cluster 310 that comprises a group of servers 311-314 that each are running Windows Server 8 and that employs Windows Server 8 CSV. Cluster 310 has been configured (i.e. each server has been configured with the Windows Server 8 operating system, the Hyper-V role has been installed, and one or more shared volumes may have been created using Windows Server 8 CSV). Although not shown, cluster 300 and cluster 310 are connected by one or more physical networks to enable data to be transferred between the two clusters.

At this point, the administrator decides that he would like to transfer configuration of VM 306 from cluster 300 to cluster 310. Without the tool of the present invention, this would require that the administrator create and configure a VM on one of the nodes of cluster 310 from scratch. In other words, the administrator would be required to manually enter each configuration setting (e.g. mapping) to create a new VM. This can be tedious and error prone because there are many configuration settings, and the administrator may not even know which configuration settings to apply to create a VM that matches VM 306. This may be especially true because cluster 310 is running a different operating system and employing a different version of CSV than cluster 300.

To enable the automatic configuration transfer of VM 306 from cluster 300 to cluster 310, the administrator can employ tool 205 as described with respect to FIG. 2 (which is now shown as executing on server 311). For example, the administrator can specify that the configuration of VM 306 is to be transferred to cluster 310. Tool 205 can receive this input and automatically transfer the configuration of VM 306 to cluster 310. As described above, tool 205 can examine the configuration settings associated with VM 306 and modify the configuration settings to configure a VM 316 on server 312 in cluster 310 so that VM 316 functions in the same manner as VM 306.

More specifically, tool 205 first identifies the CSVs (340) used in cluster 300 that VM 306 depends on (including identifying mappings from VM 306 to required files stored on the CSVs). Tool 205 then stages VM 316 in cluster 310 based on the identified mappings including modifying the mappings used by VM 306 so that the modified mappings map VM 316 to the CSVs in cluster 310 (including remapping VM 316 to the required volumes (or files) in the CSVs in cluster 310). For example, by configuring VM 316 with the modified mappings, an application executing on VM 316 can use the same namespace path to access a file located on a CSV as the application used when executing on VM 306 to access the same file.

Tool 205 can then inform the administrator that the transfer of the configuration of VM 306 has been successfully performed. In response, the administrator can stop VM 306 and the CSVs on cluster 300, perform any necessary reconfiguration on storage 330 (e.g. physically connect cluster 310 to storage 330, mask the disks/LUNs such that they are available to cluster 310 and not to cluster 300), and start VM 316 and the CSVs on cluster 310. Alternatively, tool 205 could stop VM 306 and the CSVs on cluster 300, as well as start VM 316 and the CSVs on cluster 310. Similarly, if both clusters are connected to storage 330, tool 205 could also make any necessary reconfigurations to storage 330 to allow cluster 310 to access storage 330.

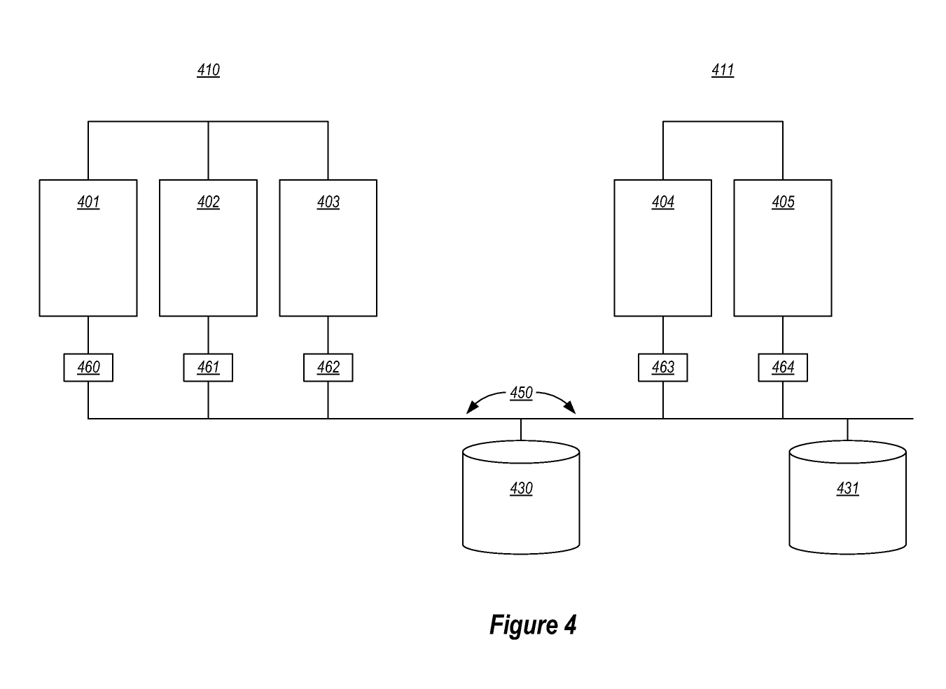

FIG. 4 illustrates various specific scenarios in which the configuration transfer techniques of the present invention can be implemented. FIG. 4 represents the scenario when an administrator is replacing less powerful servers or servers running an older operating system (servers 401-403 in cluster 410) with newer or updated servers (servers 404-405 in cluster 411). Even though this example shows three servers being replaced with two servers, the example applies to a replacement of any number of servers with any number of servers. Replacing a server includes moving VMs running on an old server to a different server that may already be hosting other VMs (i.e. the new server may already be part of an active cluster).

In the example of FIG. 4, storage 430 is being moved (either physically (e.g. by physically disconnecting cluster 410 from and physically connecting cluster 411 to storage 430) or logically) to cluster 411 such that all VMs running on cluster 410 are to be transferred to cluster 411. Remapping of VM configuration may be required in two specific scenarios in this example. First, if cluster 411 already employs a shared storage (e.g. storage 431) that has the same name as storage 430 used by cluster 410, tool 205 can rename storage 430. Because storage 430 is renamed, tool 205 can remap each VM's configuration so that each VM can find the required files on storage 430 once it is renamed.

Second, if cluster 411 already includes virtual network switches (e.g. 463-464) and these switches are connected to the same physical network (e.g. 450) that cluster 410 uses but have different names/identifiers than the virtual network switches (e.g. 460-462) used by cluster 410 to connect to the same physical network, tool 205 can identify the matching switches used by cluster 411 and reconfigure each VM's configuration to use the matching switches.

In addition to transferring configuration of a virtual machine to a new cluster, the techniques of the present invention are equally applicable to transferring configurations of other types of workloads to new clusters. For example, using the tool of the present invention, an administrator can specify that an SMB file server configuration be transferred from an old cluster to a new cluster. Similar to the VM scenario, the tool will examine configuration settings associated with the SMB file server, and automatically configure an SMB file server on the new cluster based on the determined configuration settings.

Examples of the type of configuration settings that are determined and transferred include the storage that the file server depends on, the network name by which shares exposed by the file server are accessed, and the file path and access permissions for each share. Similar to the VM example above, it may be necessary to modify each of these configuration settings so that the SMB file server in the new cluster will function in a similar manner as the SMB file server functioned in the old cluster. For example, it may be necessary to modify mappings to storage used by the file server, or to modify the network name, file path, or access permissions associated with the SMB file server.

When transferring configuration of a workload (e.g. a VM or SMB file server), it is oftentimes desirable to verify that a newly configured workload is configured according to an administrator's desires or specifications. To facilitate this verification, the tool of the present invention uses staging as mentioned above. Staging refers to the creation and configuration of a workload in a staged environment before the workload is deployed. In this description and the claims, a workload that is configured in this manner is referred to as a staged (or planned) workload (e.g. a staged VM).

By staging a workload, the workload can be configured appropriately and verified prior to the workload being deployed to further minimize any disruption from transferring the workload. For example, a workload is generally used to provide functionality to external users (e.g. a distributed application providing online functionality to users). If the workload is not staged, it is more likely that a user will experience glitches (e.g. from mis-configurations) when the processing is transferred from the workload on the old cluster to the workload on the new cluster.

Accordingly, the tool of the present invention creates a staged workload on the new cluster which is configured according to the determined configuration settings of the workload on the old cluster. Once fully configured, the tool can verify that the new workload will function as intended, after which, the workload can be deployed to replace the old workload.

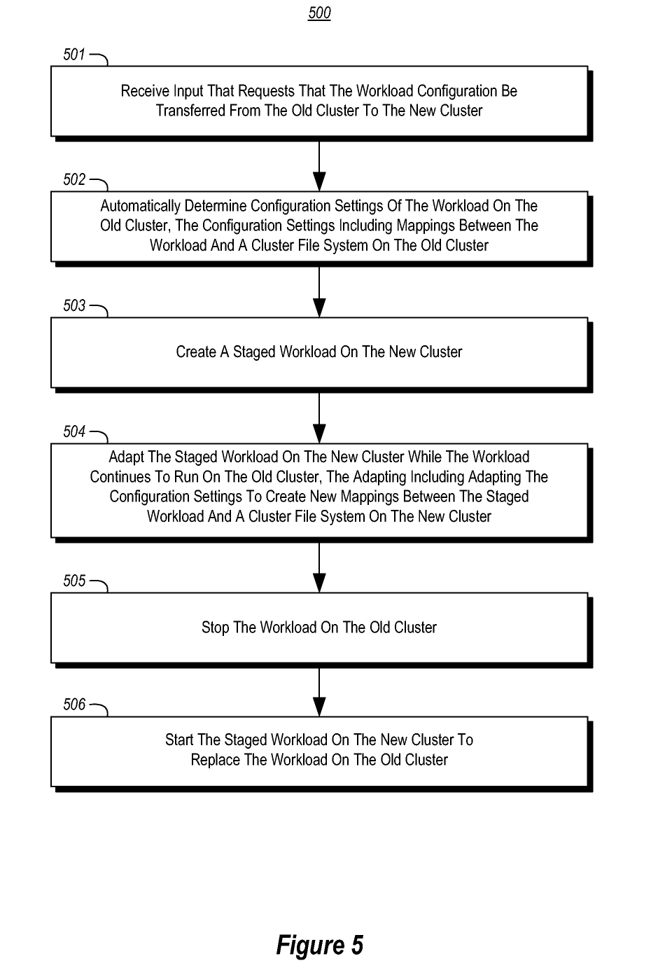

FIG. 5 illustrates a flow chart of an example method 500 for automatically transferring configuration of a workload from an old cluster to a new cluster. Method 500 will be described with respect to the components and data of computer architecture 100.

Method 500 includes an act 501 of receiving input that requests that the workload configuration be transferred from the old cluster to the new cluster. For example, an administrator can select one or more workloads using user interface 205a to be transferred from cluster 120 to cluster 130.

Method 500 includes an act 502 of automatically determining configuration settings of the workload on the old cluster. The configuration settings include mappings between the workload and a cluster file system on the old cluster. For example, tool 205 can determine configuration settings 201a of workload 201. These configuration settings can include mappings to a cluster file system on storage 105.

Method 500 includes an act 503 of creating a staged workload on the new cluster. For example, tool 205 can create a staged workload, such as staged VM 203, on server 110 of cluster 130.

Method 500 includes an act 504 of adapting the staged workload on the new cluster while the workload continues to run on the old cluster. The adapting includes adapting the configuration settings to create new mappings between the staged workload and a cluster file system on the new cluster. For example, tool 205 can adapt staged VM 203 by modifying the mappings used by VM 201 so that the mappings map to a cluster file system used by cluster 130.

Method 500 includes an act 505 of stopping the workload on the old cluster. For example, VM 201 can be stopped on server 104.

Method 500 includes an act 506 of starting the staged workload on the new cluster to replace the workload on the old cluster. For example, staged VM 203 can be deployed on server 110 to commence executing in place of VM 201.

Although method 500 has been described with reference to a VM workload, method 500 can also be implemented when transferring the configuration of an SMB file server workload.

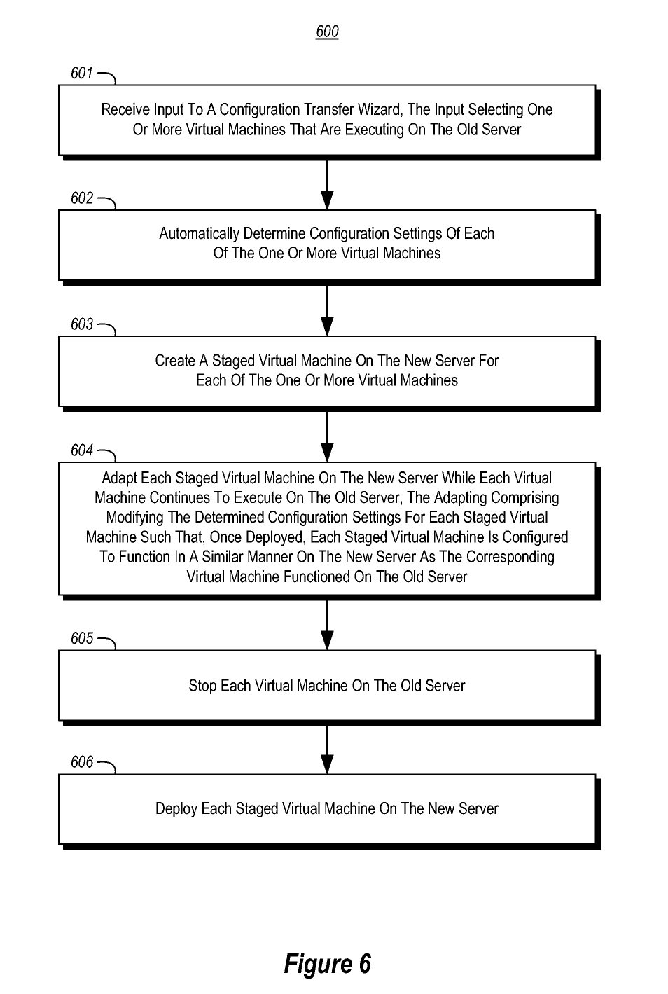

FIG. 6 illustrates a flow chart of an example method 600 for automatically transferring configuration of one or more virtual machines from an old server to a new server. Method 600 will be described with respect to the components and data of computer architecture 100.

Method 600 includes an act 601 of receiving input to a configuration transfer wizard, the input selecting one or more virtual machines that are executing on the old server. For example, tool 205 can receive input that selects one or more VMs (such as VM 201) that are executing on server 104.

Method 600 includes an act 602 of automatically determining configuration settings of each of the one or more virtual machines. For example, tool 205 can determine configuration settings 201a for VM 201. The configuration settings can be determined by inspecting various data stored within cluster 120 or in storage 105, by inspecting the configuration of cluster 120 (e.g. the server, network, or storage architecture used by cluster 120), etc.

Method 600 includes an act 603 of creating a staged virtual machine on the new server for each of the one or more virtual machines. For example, staged VM 203 can be created on server 110.

Method 600 includes an act 604 of adapting each staged virtual machine on the new server while each virtual machine continues to execute on the old server, the adapting comprising modifying the determined configuration settings for each staged virtual machine such that, once deployed, each staged virtual machine is configured to function in a similar manner on the new server as the corresponding virtual machine functioned on the old server. For example, staged VM 203 can be adapted by modifying configuration settings 201a obtained from VM 201 so that the modified configuration settings are appropriate for server 110 to enable VM 203 to function in a similar manner as VM 201.

Method 600 includes an act 605 of stopping each virtual machine on the old server. For example, VM 201 can be stopped on server 104.

Method 600 includes an act 606 of deploying each staged virtual machine on the new server. For example, staged VM 203 can be deployed on server 110.

In summary, the present invention enables the automatic transfer of the configuration of a workload between nodes or clusters including when the nodes or clusters are running different operating systems, have different architecture, or have different file system or network configurations. Accordingly, the present invention provides an upgrade path for upgrading servers in a cluster without having to manually configure workloads in the upgraded server.

In comparison to migration, the present invention enables moving a workload in many more scenarios. In order to provide high availability, migration has strict requirements for when it can be used. The configuration transfer techniques of the present invention are not limited by such requirements. In a specific embodiment, the present invention enables the configuration of a Hyper-V role in Windows Server 2008 R2 to be automatically transferred to Windows Server 8. The present invention also enables the configurations of a Hyper-V role in Windows Server 8 to be automatically transferred to another Windows Server 8 node.

In another specific embodiment, the present invention enables the configuration of a SMB2 Scale Out File Server on Windows Server 8 to be automatically transferred to another Windows Server 8 node.

In these specific embodiments, the transfer of the configuration of each role can be performed as described above, including staging a VM in a staged (or planned) VM. Existing migration tools do not allow a VM or an SMB file server to be migrated in such scenarios.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method for automatically transferring configuration of a workload from an old cluster to a new cluster, the method comprising:
receiving input that requests that the workload configuration be transferred from the old cluster to the new cluster;
automatically determining configuration settings of the workload on the old cluster, the configuration settings including mappings between the workload and a cluster file system on the old cluster;
creating a staged workload on the new cluster;
adapting the staged workload on the new cluster while the workload continues to run on the old cluster, the adapting including adapting the configuration settings to create new mappings between the staged workload and a cluster file system on the new cluster;
stopping the workload on the old cluster; and
starting the staged workload on the new cluster to replace the workload on the old cluster.

2. The method of claim 1, wherein the configuration settings further include mappings between the workload and one or more network components used by the old cluster such that adapting the staged workload also includes adapting the configuration settings to create new mappings between the staged workload and one or more network components used by the new cluster.

3. The method of claim 2, wherein the one or more network components used by the old and new cluster are virtual network switches.

4. The method of claim 3, wherein the one or more virtual network switches used by the old cluster and the one or more virtual network switches used by the new cluster connect the old and the new cluster to the same physical network.

5. The method of claim 4, wherein creating new mappings includes creating new mappings to the one or more virtual network switches used by the new cluster.

6. The method of claim 1, wherein creating new mappings between the staged workload and a cluster file system on the new cluster comprises creating new mappings to files used by the workload that are stored in the cluster file system on the new cluster.

7. The method of claim 1, wherein the name by which files are accessed in the cluster file system in the old cluster is changed to a different name in the new cluster.

8. The method of claim 1, wherein the new mappings conform the staged workload to the cluster file system on the new cluster which differs from the cluster file system on the old cluster.

9. The method of claim 1, wherein the workload is a hypervisor workload.

10. The method of claim 9, wherein the hypervisor workload is one or more virtual machines.

11. The method of claim 1, wherein the workload is an SMB file server.

12. The method of claim 1, wherein the workload is a SQL server.

13. The method of claim 1, further comprising:
prior to stopping the workload on the old cluster and storing the stage workload on the new cluster, verifying that the adapted staged workload conforms to specified rules.

14. The method of claim 11, wherein automatically determining configuration settings of the SMB file server on the old cluster, includes determining storage that the SMB file server depends on.

15. The method of claim 11, wherein automatically determining configuration settings of the SMB file server on the old cluster, includes determining the network name by which shares exposed by the SMB file server are accessed.

16. The method of claim 11, wherein automatically determining configuration settings of the SMB file server on the old cluster, includes determining file path and access permissions for each share exposed by the SMB file server.

17. The method of claim 1, further comprising:
connecting the new cluster to a storage device used by the old cluster.

18. A method for automatically transferring configuration of one or more virtual machines from an old server to a new server, the method comprising:
receiving input to a configuration transfer wizard, the input selecting one or more virtual machines that are executing on the old server;
automatically determining configuration settings of each of the one or more virtual machines;
creating a staged virtual machine on the new server for each of the one or more virtual machines;
adapting each staged virtual machine on the new server while each virtual machine continues to execute on the old server, the adapting comprising modifying the determined configuration settings for each staged virtual machine such that, once deployed, each staged virtual machine is configured to function in a similar manner on the new server as the corresponding virtual machine functioned on the old server;
stopping each virtual machine on the old server; and
deploying each staged virtual machine on the new server.

19. The method of claim 18, wherein modifying the determined configuration settings comprises, for at least one of the staged virtual machines:
modifying one or more mappings to one or more volumes in a clustered file system used by the virtual machine on the old server so that the one or more modified mappings map to one or more volumes in a clustered file system to be used by the staged virtual machine on the new server; and
modifying one or more mappings to one or more virtual network switches used by the virtual machine on the old server to connect to a physical network so that the one or more modified mappings map to one or more virtual network switches to be used by the staged virtual machine on the new server to connect to the same physical network.

20. A method, performed by a configuration transfer wizard, for automatically transferring configuration of one or more virtual machines from an old cluster to a new cluster, the method comprising:
receiving user input, to the configuration transfer wizard, the user input specifying a plurality of virtual machines that are executing on an old cluster, the user input requesting that the configuration of each of the virtual machines be transferred to the new cluster;
accessing, by the configuration transfer wizard, the old cluster to obtain configuration settings for each of the virtual machines, the configuration settings including:
mappings to one or more volumes of a clustered file system on the old cluster that the virtual machines use to access files; and
mappings to one or more virtual network switches that the old cluster uses to connect to a physical network;
for each virtual machine in the old cluster, the configuration transfer wizard creating a staged virtual machine in the new cluster;
accessing, by the configuration transfer wizard, the new cluster to identify one or more volumes of a clustered file system on the new cluster to be used by the staged virtual machines when executed on the new cluster, and to identify one or more virtual network switches that the new cluster uses to connect to the physical network; and
modifying the configuration settings obtained for each of the virtual machines in the old cluster and applying the modified configurations settings to the corresponding staged virtual machine in the new cluster, modifying the configuration settings including:
modifying the mappings to the one or more volumes of the cluster file system on the old cluster so that the modified mappings map to one or more volumes of the cluster file system on the new cluster that the staged virtual machines will use to access files; and
modifying the mappings to the one or more virtual network switches that the old cluster uses to connect to the physical network so that the modified mappings map to one or more virtual network switches that the new cluster uses to connect to the physical network.
